(19) United States
(12) Patent Application Publication
(10) Pub. No.: US 2018/0137178 A1
(43) Pub. Date: May 17, 2018

(54) ACCESSING DATA AND PERFORMING A DATA PROCESSING COMMAND ON THE DATA WITH A SINGLE USER INPUT

(71) Applicant: International Business Machines Corporation, Armonk, NY (US)

(72) Inventors: David J. Corbett, Medway, MA (US); Sean M. McDowell, Ottawa (CA)

(21) Appl. No.: 15/349,505

(22) Filed: Nov. 11, 2016

(51) Int. Cl. G06F 17/30; G06F 17/27; G06F 3/0482

(52) U.S. Cl. CPC G06F 17/30528; G06F 17/30554; G06F 17/273; G06F 3/04895; G06F 17/271; G06F 17/2725; G06F 3/0482

(57) ABSTRACT

A single user input can be received from a user in a command entry field of a graphical user interface of a data analytics client. The single user input can specify at least one category of data and at least one data processing command to be performed on the at least one category of data. At least one query according to the single user input can be generated and communicated to a data service or a data source. Data comprising the at least one category of data can be received from the data service or the data source. At least one data processing command specified by the single user input can be performed on the at least one category of data received from the data service or the data source. Results of performing on the at least one category of data the data processing command can be output.

### BACKGROUND

The present invention relates to data processing systems, and more specifically, to implementing user commands in a data processing system.

A graphical user interface (GUI) is a type of user interface that allows users to interact with data processing systems through graphical icons and visual indicators. Actions in a GUI typically are performed through manipulation of graphical elements, such as menus, buttons and icons. For example, if a user wishes to underline a word in a word processing document, the user may enter a first user input to highlight a word, then enter a second user input to select a graphical button for the underline command.

### SUMMARY

A method includes receiving from a user, in a command entry field of a graphical user interface of a data analytics client, a single user input, the single user input specifying at least one category of data and at least one data processing command to be performed on the at least one category of data. The method also can include automatically generating at least one query according to the single user input and communicating the query to a data service or a data source. The method also can include, responsive to communicating the at least one query to the data service or data source, receiving from the data service or the data source data comprising the at least one category of data. The method also can include performing, using a processor, on the at least one category of data received from the data service or the data source the at least one data processing command specified by the single user input. The method also can include outputting results of performing on the at least one category of data received from the data service or the data source the data processing command specified by the single user input.

A system includes a processor programmed to initiate executable operations. The executable operations include receiving from a user, in a command entry field of a graphical user interface of a data analytics client, a single user input, the single user input specifying at least one category of data and at least one data processing command to be performed on the at least one category of data. The executable operations also can include automatically generating at least one query according to the single user input and communicating the query to a data service or a data source. The executable operations also can include, responsive to communicating the at least one query to the data service or data source, receiving from the data service or the data source data comprising the at least one category of data. The executable operations also can include performing on the at least one category of data received from the data service or the data source the at least one data processing command specified by the single user input. The executable operations also can include outputting results of performing on the at least one category of data received from the data service or the data source the data processing command specified by the single user input.

A computer program includes a computer readable storage medium having program code stored thereon. The program code is executable by a processor to perform a method. The method includes receiving, by the processor, from a user, in a command entry field of a graphical user interface of a data analytics client, a single user input, the single user input specifying at least one category of data and at least one data processing command to be performed on the at least one category of data. The method also can include automatically generating, by the processor, at least one query according to the single user input and communicating the query to a data service or a data source. The method also can include, responsive to communicating the at least one query to the data service or data source, receiving, by the processor, from the data service or the data source data comprising the at least one category of data. The method also can include performing, by the processor, on the at least one category of data received from the data service or the data source the at least one data processing command specified by the single user input. The method also can include outputting, by the processor, results of performing on the at least one category of data received from the data service or the data source the data processing command specified by the single user input.

### BRIEF DESCRIPTION OF THE DRAWINGS

FIG. 1 is a diagram illustrating an example of a graphical user interface of a data analytics client.

FIG. 2 is another diagram illustrating an example of a graphical user interface of a data analytics client.

FIG. 3 is another diagram illustrating an example of a graphical user interface of a data analytics client.

FIG. 4 is a flow chart illustrating an example of a method of performing processing commands on categories of data responsive to receiving a single user input in a command entry field.

FIG. 5 is a block diagram illustrating example architecture for a data processing system.

### DETAILED DESCRIPTION

This disclosure relates to data processing systems, and more specifically, to implementing user commands in a data processing system. In accordance with the arrangements described herein, a command entry field configured to receive user inputs is provided in a graphical user interface of a data analytics client. In the command entry field, a user can enter a single user input specifying at least one category of data and at least one data processing command to be performed on the at least one category of data. Responsive to receiving the single user input, the data analytics client can automatically generate results for the single user input. Specifically, the data analytics client can select the specified category/categories of data, and perform on the category/categories of data the specified data processing command(s).

Accordingly, rather than providing multiple user inputs (e.g., menu, button and/or icon selections), using the command entry field the user can, with a single user input, initiate selection of one or more categories of data and initiate one or more data processing commands on the category/categories of data. This can serve to streamline the user's interactions with the data analytics client, saving the user valuable time and improving user productivity. Moreover, in comparison to using macros or computer programing commands (e.g., Visual Basic commands), the command entry field is accessible to users who are not programmers using natural language commands. In addition, such commands can be processed against data items that appear in a user interface based on the domain of the user's current analysis, rather than only on fixed user interface data items.

Several definitions that apply throughout this document now will be presented.

As defined herein, the term “command entry field of a graphical user interface of a data analytics client” means a user input field, presented in a graphical user interface of a data analytics client, configured to receive a text string specifying at least one category of data and at least one data processing command to be performed on the at least one category of data, wherein each of the at least one data processing command is assigned a button, icon or menu item in the graphical user interface, but the command is automatically executed in response to receiving the text string in lieu of the user selecting the button, icon or menu item. The text string can be entered by a user using a keyboard or keypad, or entered by performing speech recognition on at least one utterance spoken by a user.

As defined herein, the term “data analytics client” means a computer program, executed by at least one processor, used to access, analyze and present data, and configured to execute in a computing environment hosted by at least one operating system. As the term “data analytics client” is defined herein, an operating system is not a data analytics client. As the term “data analytics client” is defined herein, a command line interface is not a data analytics client. As the term “data analytics client” is defined herein, a database is not a data analytics client. As the term “data analytics client” is defined herein, a database application is not a data analytics client. As the term “data analytics client” is defined herein, a web browser is not a data analytics client.

As defined herein, the term “operating system” means a computer program that, after being initially loaded into a data processing system, manages other computer programs in the data processing system.

As defined herein, the term “command line interface” means an application presented by an operating system in which a user responds to a visual prompt by entering a command on a specified line, and receives a response back from the operating system. The MS-DOS Prompt application in a Windows® operating system is an example of a “command line interface.”

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “output” means storing in memory elements, writing to display or other peripheral output device (e.g., a printer), sending or transmitting to another system, exporting, or similar operations.

As defined herein, the term “automatically” means without user intervention.

As defined herein, the term “user” means a person (i.e., a human being).

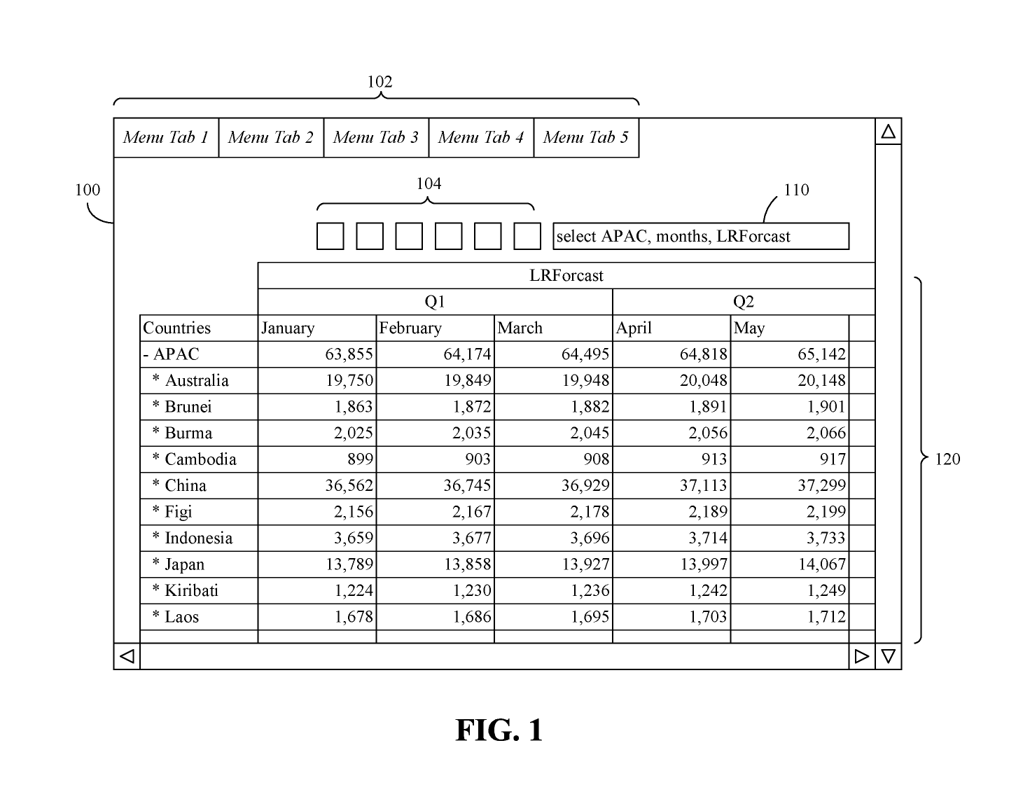

FIG. 1 is a block diagram illustrating an example of a graphical user interface (GUI) 100 of a data analytics client. The GUI 100 can include one or more menus 102, for example menu tabs, drop down menus, etc., and a plurality of buttons/icons 104. Using one or more of the menus 102 and/or buttons/icons 104, a user may select data. Again using the menus 102 and/or buttons/icons 104, the user may initiate commands on selected data. For example, the user may provide a first user input to select a particular menu item or button/icon 104 to select data, provide a second user input to select a particular menu item or button/icon 104 to initiate a first processing command on the selected data, and provide a third user input to select a particular menu item or button/icon 104 to initiate a second processing command on the selected data, and so on.

The GUI 100 also can include a command entry field 110, for example a snap command entry field. Rather than selecting multiple menu items and/or buttons/icons 104 to select data and initiate one or more processing commands to be performed on the data, the user can enter a single user input into the command entry field 110. The single user input can specify at least one category of data and at least one data processing command to be performed on the at least one category of data. Responsive to receiving the single user input in the command entry field 110, the data analytics client can select the at least one category of data specified by the single user input and perform on the at least one category of data the at least one data processing command specified by the single user input. The single user input can include text sting comprising alphanumeric characters and, optionally, one or more non-alphanumeric characters (e.g., symbols).

In one arrangement, the user can enter the text string into the command entry field 110 using a keyboard and/or keypad to type a text string comprising a plurality of characters. In another arrangement, the user can enter the text string into the command entry field 110 by uttering the text string into an input audio transducer (e.g., microphone). The data analytics client, or speech recognition application interfacing with the data analytics client, can receive the spoken utterances and perform speech recognition on the spoken utterances to generate the text string from the spoken utterances. For example, the input audio transducer can be coupled to an analog to digital (A/D) converter which converts the spoken utterances from an analog signal to a digital signal. The data analytics client, or speech recognition application, can receive the digital signal and process the digital signal to generate the text. Speech recognition is well known to those of ordinary skill in the art.

By way of example, a user can enter into the command entry field 110 the text “select APAC, months, LRForcast.” In response to the user input, the data analytics client can search across an entire scope of a data array for possible matches for the terms “APAC,” “Months” and “LRForecast.” For instance, the data array may contain the categorical hierarchies “Region,” “Time,” “Products,” and “Versions,” each of which may contain members, sets (e.g., designated collections of members), and levels (e.g., members sharing a common generation from a root member). In this example, the user can enter the single user input to transform the data array to show country members in the APAC Set on rows of a data array (e.g., data grid), show Month level of periods on columns of the data array, and orient the data to an LRForecast Version member. All of these collections of items can be searched for a match to the user's terms.

In one arrangement, all items may not already loaded into the data analytics client, so the data analytics client can perform the search on a data source (e.g., a database) that contains the complete set of the data. In illustration, the data analytics client can automatically generate at least one query according to the single user input. For example, the data analytics client can generate a query specifying “APAC,” “Months” and “LRForecast” as search criteria, and communicate the query to one or more data services (e.g., data bases). Responsive to communicating the query, the data analytics client can receive one or more responses from the data service(s) including data fitting the search criteria, and output the data.

In illustration, the data analytics client can prepare a set of one or more queries according to one or more command types and search terms contained in the text of the single user input entered into the command entry field 110. The data analytics client can communicate the query/queries to one or more data search services or data sources (e.g., data bases), for example via one or more communication networks. In the case the query/queries are communicated to one or more data search services, the data search services can issue the query/queries to one or more data sources. The following is an example of such a query for a search request which may be generated by the data analytics client:
https://prism-stage.cognostml.ibmcloud.com/prism/harmony/question/Servers(%27smartco%27)/search?q=europe&objType=element&threshold=0.2&maxResults=10&type=similarity&attributes=Name&attributes=Caption&hierarchies=%5BMonth%5D %5BMonth%5D

In this example, “q=europe” indicates query text “europe,” “objType=element” indicates search objects of type “element,” “threshold=0.2” indicates return results with a confidence of at least 0.2 (scored from 0.0 to 1.0), “maxResults=10” indicates return the top 10 results, “type=similarity” indicates to use a similarly matching algorithm, “attributes=Name” and “attributes=Caption” indicate attributes to be searched, and “hierarchies=%5BMonth%5D %5BMonth%5D” indicates search a Month/Month hierarchy. The data search services or data sources can process the query to select the data indicated by the search query. Optionally, the data search services can perform additional searches based on the results obtained from the data sources. The data search services or data sources can communicate to the data analytics client data resulting from the query/queries (i.e., search results).

Responsive to the search results being received by the data analytics client, the data analytics client can collect the search results and perform an appropriate action, for example outputting the search results, executing a processing command indicated in the text of the single user input on the search results and outputting results of such processing, or outputting a list of hits corresponding to the single user input. In illustration, processing commands indicated by the single user input can be performed by the data analytics client on data contained in the search results. For example, if the single user input specifies one or more processing commands to be performed on the data, the data analytics client can perform the processing commands on the data responsive to receiving the data, and output results of the processing commands. Further, the user may provide one or more supplemental single user inputs specifying one or more commands into the command entry field 110, and the data analytics client can perform the processing commands on the data responsive to receiving such user inputs.

In the above example the results obtained using the single user input are equivalent to results that otherwise would be obtained by the user performing the following user gestures using menus 102, icons and/or buttons 104 in the GUI 100: navigate to the Region hierarchy, expand the Members collection, scroll to APAC countries and drag and drop APAC countries onto a data array grid, navigate to the Time dimension, expand the Members collection, scroll to individual months February, and drag and drop data for the individual months onto the data array.

Clearly, using a single user input to enter text into the command entry field 110 as described herein is much more efficient. Indeed, in lieu of selecting menu items from the menus 102 or selecting icons and/or buttons 104, the text of the single user input can include one or more data processing commands that are each assigned a respective menu item, button and/or icon 104 in the GUI 100. Typing or speaking such data processing commands, however, can be much quicker than navigating the menus 102 or selecting the icons and/or buttons 104 in the GUI 100.

In another example, sorting or filtering processing commands can be implemented using a single user gesture entered into the command entry field 110. A single user input including the text “HSort Q1” will initiate the data analytics client to perform a Hierarchical Sort of the data represented by the Q1 Time period. If the search results in more than one “hit” to the search terms, the data analytics client can present to the user a list of items matching the search criteria, as well as a confidence figure. The user can select from amongst these results or refine their user input if necessary.

The data analytics client also can validate the text entered into the command entry field 110 to determine whether the text is syntactically correct. In one arrangement, responsive to determining that the single user input is not syntactically correct, the data analytics client can prompt the user to revise the single user input, for example by presenting a pop up window in the GUI 100. The user can revise the text of the single user input, and the data analytics client can again validate the revised text. In another arrangement, responsive to determining that the single user input is not syntactically correct, the data analytics client can automatically revise the single user input to make the single user input syntactically correct. For example, the data analytics client can parse terms or term fragments from the text of the single user input, identify which parsed terms or term fragments correspond to data categories and which parsed terms or term fragments correspond to data processing commands, and create new text including terms corresponding to the parsed terms or term fragments, wherein the corresponding terms are provided in the new text in a syntactically correct manner. To do so, the data analytics client can access and process defined syntax rules. Responsive to determining that the revised text is syntactically correct, the data analytics client can process the revised text to automatically obtain and/or sort data, process the data, etc. to generate results.

In one aspect of the present arrangements, the data analytics client can implement inexact or fuzzy matching to allow a user to save time by entering term fragments. In illustration, the data analytics client can interpret user input text by matching groups of characters in the user input text to more complete versions of the character groups. For example, the user may enter the text “sel eur, feb” into the command entry field 110 as a single user input. The data analytics client can identify the individual portions “sel,” “eur” and “feb” of the text “sel eur, feb” as being term fragments, and convert the term fragments to complete terms. For example, the data analytics client can convert the term fragments “sel eur, feb” to “Select Europe, February,” and process “Select Europe, February” to select data for Europe and the month of February. To convert the term fragments, the data analytics client can identify terms that contain (e.g., begin with) the term fragments, and select the identified terms to replace the term fragments when processing the single user input.

The data analytics client also can determine whether one or more terms in the text of the single user input is ambiguous. For example, if the user enters a term fragment, but more than one term contains the term fragment, the data analytics client can identify the term fragment as being ambiguous. For example, the term or term fragment can correspond to a plurality of categories and/or data processing commands. By way of example, the data analytics client also can determine a specified category of data is ambiguous if there are one or more categories that match the specified category that are not each subcategories of another category, or are categories for which there is no established relationship. In illustration, if the text of the single user input specifies a category “fin,” but data sources being accessed by the data analytics client include a “Finland” category, a “finalized” category, and a “financials” category, the data analytics client can determine the category “fin” to be ambiguous.

Responsive to determining that a term or term fragment specified by the single user input is ambiguous, the data analytics client can identify a plurality of terms, such as data processing commands or categories of data, that potentially correspond to the entered term or term fragment, e.g., “Finland,” “finalized” and “financials.” The data analytics client can present to the user, for example via a pop up window in the GUI 100, the plurality of terms that potentially correspond to the entered term or term fragment, and prompt the user to select from the presented terms to be used to access and/or sort data. The data analytics client can automatically generate results for the single user input based on the terms selected by the user in response to the prompt.

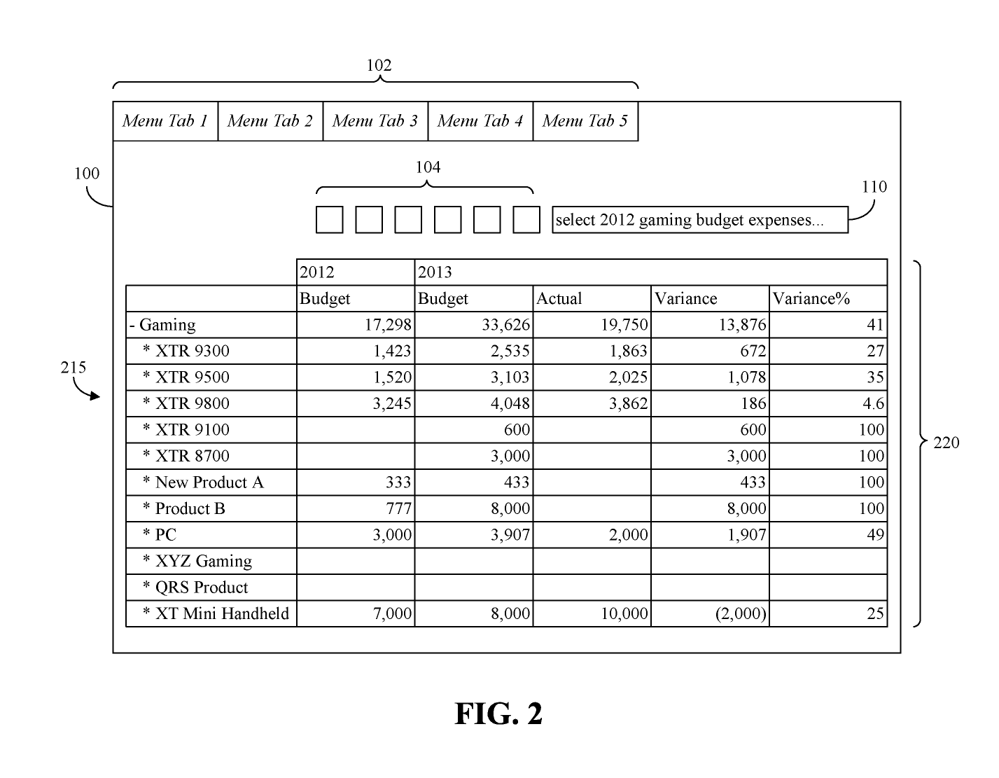

FIG. 2 is another diagram illustrating an example of a graphical user interface of a data analytics client. In this example, hierarchical categories can be placed on rows of a data array 215, and columns and titles of the data array 215 can define the data presented in the data array 215. In this example, members of the hierarchical categories are shown in row and column headers.

A user can enter into the command entry field 110 a single user input comprising the following text:
select 2012 gaming budget expenses, 2013 gaming budget
expenses and actual expenses, and for 2013 gaming calculate
variance and variance%
   In this example, the single user input specifies the categories “2012 gaming budget expenses,” “2013 gaming budget expenses” and “2013 gaming actual expenses.” The single user input also specifies the processing command “select” to be performed to present the “2012 gaming budget expenses,” “2013 gaming budget expenses” and “2013 gaming actual expenses” in the GUI 100, and specifies the processing command “calculate” to calculate the “2013 gaming variance” and “2013 gaming variance%” based on the “2013 gaming budget expenses” and “2013 gaming actual expenses.”

The data analytics client can automatically generate results 220 for the single user input by selecting the specified categories and performing the specified processing commands on the specified categories. For example, the data analytics client can execute the “select” processing command to select the categories “2012 gaming budget expenses,” “2013 gaming budget expenses” and “2013 gaming actual expenses.” To implement the “select” processing command, the data analytics client can automatically create a query to query a data source (e.g., database) continuing data for the categories “2012 gaming budget expenses,” “2013 gaming budget expenses” and “2013 gaming actual expenses.” The data analytics client can communicate the query to the data source and receive data for the selected categories from the data source in response to the query. Further, the data analytics client can execute the “compute” processing command on the data for the selected categories to calculate the “2013 gaming variance” and the “2013 gaming variance%.”

The data analytics client can output the results 220 from the data selection and processing commands. For instance, the data analytics client can output the results 220 to a display for presentation in the GUI 100, output the results 220 to a printer, output the results 220 to a file, and so on. In this example, the results 220 are generated by performing an analysis on a multi-dimensional data set including the “gaming” category.

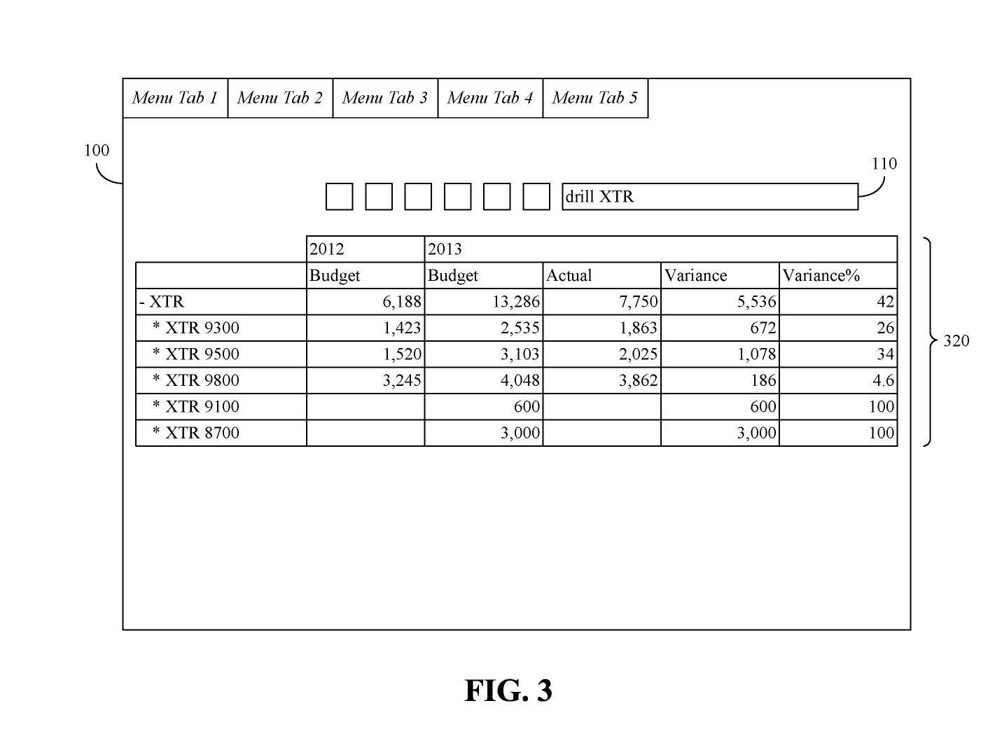

The user also can enter another single user input into the command entry field 110 to select one or more categories contained in the result 220 and perform processing commands on those categories. For example, the user can enter into the command entry field 110 a single user input comprising the following text: “drill XTR.” In this example, the single user input specifies the category “XTR” contained in the results 220 and the “drill” processing command to drill down to the “XTR” category (e.g., filter the results 220 to only present the “XTR” category). The data analytics client can automatically generate results 320 for the other single user input, as shown in FIG. 3. In this example, the results 320 are generated by performing an analysis on a multi-dimensional data set including the “XTR” category, which is a subcategory of the “gaming” category.

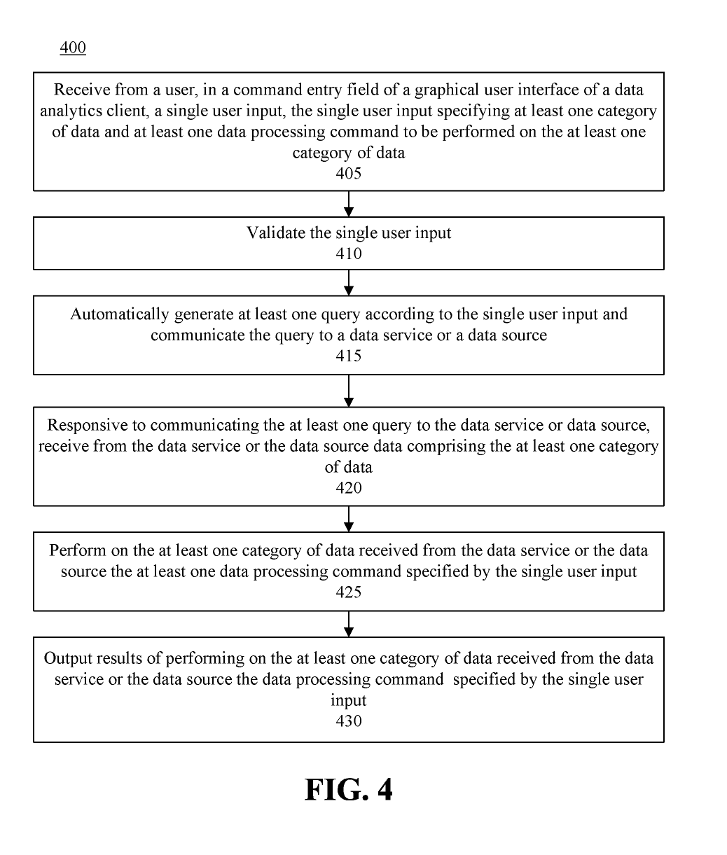

FIG. 4 is a flow chart illustrating an example of a method 400 of performing processing commands on categories of data responsive to receiving a single user input in a command entry field. At step 405 a data analytics client can receive from a user, in a command entry field of a graphical user interface of the data analytics client, a single user input, the single user input specifying at least one category of data and at least one data processing command to be performed on the at least one category of data. At step 410, the data analytics client can validate the single user input. At step 415, the data analytics client can automatically generate at least one query according to the single user input and communicate the query to a data service or a data source. At step 420, the data analytics client can, responsive to communicating the at least one query to the data service or data source, receive from the data service or the data source data comprising the at least one category of data. At step 425, the data analytics client can perform on the at least one category of data received from the data service or the data source the at least one data processing command specified by the single user input. At step 430, the data analytics client can output results of performing on the at least one category of data received from the data service or the data source the data processing command specified by the single user input.

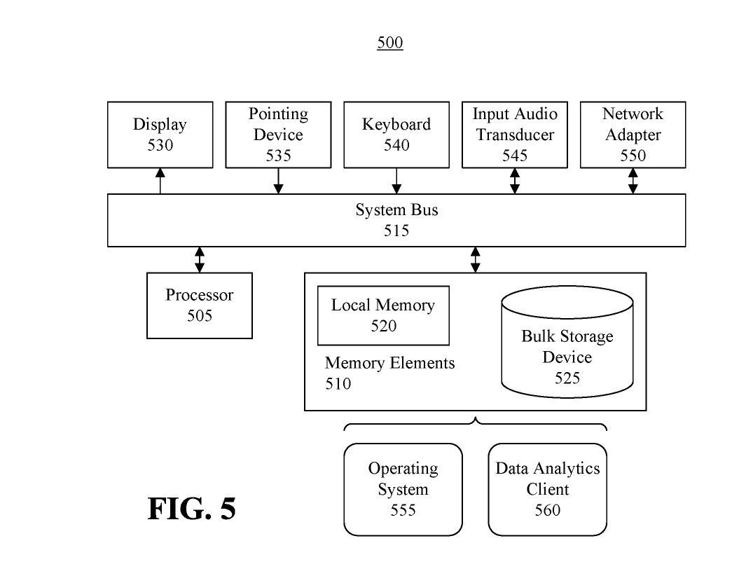

FIG. 5 is a block diagram illustrating example architecture for a data processing system 500 configured to receive and process single user inputs as disclosed within this specification.

The data processing system 500 can include at least one processor 505 (e.g., a central processing unit) coupled to memory elements 510 through a system bus 515 or other suitable circuitry. As such, the data processing system 500 can store program code within the memory elements 510. The processor 505 can execute the program code accessed from the memory elements 510 via the system bus 515. It should be appreciated that the data processing system 500 can be implemented in the form of any system including a processor and memory that is capable of performing the functions and/or operations described within this specification. For example, the data processing system 500 can be implemented as a server, a plurality of communicatively linked servers, a workstation, a desktop computer, a mobile computer, a tablet computer, a laptop computer, a netbook computer, a smart phone, a personal digital assistant, a set-top box, a gaming device, a network appliance, and so on.

The memory elements 510 can include one or more physical memory devices such as, for example, local memory 520 and one or more bulk storage devices 525. Local memory 520 refers to random access memory (RAM) or other non-persistent memory device(s) generally used during actual execution of the program code. The bulk storage device(s) 525 can be implemented as a hard disk drive (HDD), solid state drive (SSD), or other persistent data storage device. The data processing system 500 also can include one or more cache memories (not shown) that provide temporary storage of at least some program code in order to reduce the number of times program code must be retrieved from the bulk storage device 525 during execution.

Input/output (I/O) devices such as a display 530, a pointing device 535, a keyboard 540 and, optionally, an input audio transducer 545, can be coupled to the data processing system 500. The I/O devices can be coupled to the data processing system 500 either directly or through intervening I/O controllers. For example, the display 530 can be coupled to the data processing system 500 via a graphics processing unit (GPU), which may be a component of the processor 505 or a discrete device. The input audio transducer can be coupled to the data processing via an A/D converter. One or more network adapters 550 also can be coupled to data processing system 500 to enable the data processing system 500 to become coupled to other systems, computer systems, remote printers, and/or remote storage devices through intervening private or public networks. For example, the data processing system 500 can couple to one or more data services and/or data sources via one or more communication networks (e.g., the Internet) using the network adapter 550. Modems, cable modems, transceivers, and Ethernet cards are examples of different types of network adapters 550 that can be used with the data processing system 500.

As pictured in FIG. 5, the memory elements 510 can store the components of the data processing system 500, namely an operating system 555, and a data analytics client 560 configured to perform the processes described herein with reference to FIGS. 1-4. Being implemented in the form of executable program code, the operating system 555 and the data analytics client 560 can be executed by the data processing system 500 and, as such, can be considered part of the data processing system 500. Moreover, the operating system 555 and the data analytics client 560, and data arrays presented by the data analytics client 560, are functional data structures that impart functionality when employed as part of the data processing system 500.

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving from a user, in a command entry field of a graphical user interface of a data analytics client, a single user input, the single user input specifying at least one category of data and at least one data processing command to be performed on the at least one category of data;
performing, using a processor, on the at least one category of data the at least one data processing command specified by the single user input; and
outputting results of performing on the at least one category of data received from the data service or the data source the data processing command specified by the single user input.

2. The method of claim 1, further comprising:
automatically generating at least one query according to the single user input and communicating the query to a data service or a data source; and
responsive to communicating the at least one query to the data service or data source, receiving from the data service or the data source data comprising the at least one category of data.

3. The method of claim 2, wherein the at least one data processing command specified by the single user input is performed on the at least one category of data responsive to receiving from the data service or the data source the data comprising the at least one category of data.

4. The method of claim 1, further comprising:
validating the single user input to determine whether the single user input is syntactically correct;
responsive to determining that the single user input is not syntactically correct, prompting the user to revise the single user input;
receiving from the user a revision to the single user input; and
wherein automatically generating results for the single user input comprises automatically generating the results using the revised single user input.

5. The method of claim 1, further comprising:
determining whether at least one term or term fragment specified by the single user input is ambiguous;
responsive to determining that the at least one term or term fragment specified by the single user input is ambiguous, identifying a plurality of terms that potentially correspond to the at least one term or term fragment specified by the single user input; and
presenting to the user the identified plurality of terms that potentially correspond to the at least one term or term fragment specified by the single user input and prompting the user to select at least one of the identified plurality of terms;
wherein automatically generating results for the single user input comprises generating results based on the selected at least one of the identified plurality of terms.

6. The method of claim 1, further comprising:
determining whether the at least one category of data specified by the single user input is ambiguous;
responsive to determining that the at least one category of data specified by the single user input is ambiguous, identifying a plurality of categories of data that potentially correspond to the at least one category of data specified by the single user input; and
presenting to the user the identified plurality of categories of data that potentially correspond to the at least one category of data specified by the single user input and prompting the user to select at least one of the identified plurality of categories of data;
wherein automatically generating results for the single user input comprises generating results based on the selected at least one of the identified plurality of categories of data.

7. The method of claim 1, wherein:
the at least one data processing command comprises a plurality of data processing commands;
each of the plurality of data processing commands is assigned a respective button, icon or menu item in the graphical user interface; and
the single user input is received from the user in lieu of the user selecting, for each of the plurality of data processing commands, the respective button, icon or menu item.

8. A system, comprising:
a processor programmed to initiate executable operations comprising:
receiving from a user, in a command entry field of a graphical user interface of a data analytics client, a single user input, the single user input specifying at least one category of data and at least one data processing command to be performed on the at least one category of data;
performing on the at least one category of data the at least one data processing command specified by the single user input; and
outputting results of performing on the at least one category of data received from the data service or the data source the data processing command specified by the single user input.

9. The system of claim 8, the executable operations further comprising:
automatically generating at least one query according to the single user input and communicating the query to a data service or a data source; and
responsive to communicating the at least one query to the data service or data source, receiving from the data service or the data source data comprising the at least one category of data.

10. The system of claim 9, wherein the at least one data processing command specified by the single user input is performed on the at least one category of data responsive to receiving from the data service or the data source the data comprising the at least one category of data.

11. The system of claim 8, the executable operations further comprising:
validating the single user input to determine whether the single user input is syntactically correct;
responsive to determining that the single user input is not syntactically correct, prompting the user to revise the single user input;
receiving from the user a revision to the single user input; and
wherein automatically generating results for the single user input comprises automatically generating the results using the revised single user input.

12. The system of claim 8, the executable operations further comprising:
determining whether at least one term or term fragment specified by the single user input is ambiguous;
responsive to determining that the at least one term or term fragment specified by the single user input is ambiguous, identifying a plurality of terms that potentially correspond to the at least one term or term fragment specified by the single user input; and
presenting to the user the identified plurality of terms that potentially correspond to the at least one term or term fragment specified by the single user input and prompting the user to select at least one of the identified plurality of terms;
wherein automatically generating results for the single user input comprises generating results based on the selected at least one of the identified plurality of terms.

13. The system of claim 8, the executable operations further comprising:
determining whether the at least one category of data specified by the single user input is ambiguous;
responsive to determining that the at least one category of data specified by the single user input is ambiguous, identifying a plurality of categories of data that potentially correspond to the at least one category of data specified by the single user input; and
presenting to the user the identified plurality of categories of data that potentially correspond to the at least one category of data specified by the single user input and prompting the user to select at least one of the identified plurality of categories of data;
wherein automatically generating results for the single user input comprises generating results based on the selected at least one of the identified plurality of categories of data.

14. The system of claim 8, wherein:
the at least one data processing command comprises a plurality of data processing commands;
each of the plurality of data processing commands is assigned a respective button, icon or menu item in the graphical user interface; and
the single user input is received from the user in lieu of the user selecting, for each of the plurality of data processing commands, the respective button, icon or menu item.

15. A computer program product comprising a computer readable storage medium having program code stored thereon, the program code executable by a processor to perform a method comprising:
receiving, by the processor, from a user, in a command entry field of a graphical user interface of a data analytics client, a single user input, the single user input specifying at least one category of data and at least one data processing command to be performed on the at least one category of data;
performing, by the processor, on the at least one category of data the at least one data processing command specified by the single user input; and
outputting, by the processor, results of performing on the at least one category of data received from the data service or the data source the data processing command specified by the single user input.

16. The computer program product of claim 15, the method further comprising:
automatically generating at least one query according to the single user input and communicating the query to a data service or a data source; and
responsive to communicating the at least one query to the data service or data source, receiving from the data service or the data source data comprising the at least one category of data.

17. The computer program product of claim 16, wherein the at least one data processing command specified by the single user input is performed on the at least one category of data responsive to receiving from the data service or the data source the data comprising the at least one category of data.

18. The computer program product of claim 15, the method further comprising:
validating the single user input to determine whether the single user input is syntactically correct;
responsive to determining that the single user input is not syntactically correct, prompting the user to revise the single user input;
receiving from the user a revision to the single user input; and
wherein automatically generating results for the single user input comprises automatically generating the results using the revised single user input.

19. The computer program product of claim 15, the method further comprising:
determining whether at least one term or term fragment specified by the single user input is ambiguous;
responsive to determining that the at least one term or term fragment specified by the single user input is ambiguous, identifying a plurality of terms that potentially correspond to the at least one term or term fragment specified by the single user input; and
presenting to the user the identified plurality of terms that potentially correspond to the at least one term or term fragment specified by the single user input and prompting the user to select at least one of the identified plurality of terms;
wherein automatically generating results for the single user input comprises generating results based on the selected at least one of the identified plurality of terms.

20. The computer program product of claim 15, the method further comprising:
determining whether the at least one category of data specified by the single user input is ambiguous;
responsive to determining that the at least one category of data specified by the single user input is ambiguous, identifying a plurality of categories of data that potentially correspond to the at least one category of data specified by the single user input; and
presenting to the user the identified plurality of categories of data that potentially correspond to the at least one category of data specified by the single user input and prompting the user to select at least one of the identified plurality of categories of data;
wherein automatically generating results for the single user input comprises generating results based on the selected at least one of the identified plurality of categories of data.
